(19) United States
(12) Patent Application Publication
(10) Pub. No.: US 2004/0129818 A1
(43) Pub. Date: Jul. 8, 2004

(54) Tension controller of magnetic tape

(75) Inventors: Shinichi Sugawara, Kanagawa (JP); Tetsuji Nishida, Kanagawa (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/738,095

(22) Filed: Dec. 18, 2003

(30) Foreign Application Priority Data
Dec. 26, 2002 (JP) 2002-375885

(51) Int. Cl. G11B 15/46

(52) U.S. Cl. 242/334.6

(57) ABSTRACT

A tension controller of a magnetic tape to control a tension distribution in a tape width direction of a running magnetic tape to become uniform is equipped with a tension detecting unit detecting the tension distribution in the tape width direction of the magnetic tape; a tension adjusting unit pushing a weaker portion in tension in the tape width direction of the magnetic tape, and eliminating a tension difference in the tape width direction; and a control unit controlling the tension adjusting unit so that the tension in the tape width direction of the magnetic tape becomes uniform, based on a detection result of the tension detecting unit.

### FIELD OF THE INVENTION

The present invention relates to a tension controller of a magnetic tape, and in particular, relates to a controller to control tension in a width direction of a running magnetic tape to become uniform.

### BACKGROUND OF THE INVENTION

A magnetic tape drive which is a recording/reproducing apparatus of a magnetic tape and a tape running system in a winder which is a winding device of the magnetic tape is composed so as to run the magnetic tape from one reel to the other reel. Such the tape running system is requested to stably run the magnetic tape to enhance recording/reproducing characteristics of the magnetic tape and/or to prevent a winding disturbance of the magnetic tape wound on the reel.

Therefore, conventionally the tape running system gives tension in a longitudinal direction (tape running direction) of the magnetic tape and runs the tape from one reel to the other reel. And it detects the tension given to the magnetic tape in each part of the tape running system, and based on its detection result, controls the tension in the running direction of the magnetic tape (for example, see Japan patent laid open publication 2002-92998).

A “Tape Running Controller” described in the patent document is said to measure a position of a tension pole provided at one end of a tension arm by a position sensor provided at the other end of the tension arm, and based on its detection result, to adjust tension in a tape running direction of a magnetic tape by controlling a rotation drive of a supply reel.

But the magnetic tape in running is not uniform in a tension distribution in a tape width direction due to a curve of a tape itself and slants of a guide, reel, and the like in the tape running system. In other words, some tension given to the magnetic tape is one-sided in the tape width direction. If the tension given to the magnetic tape is one-sided in the tape width direction, the magnetic tape is displaced to a stronger side of the tension in the tape width direction, so there exists a problem that the magnetic tape cannot be stably run.

In addition, the tension given to the magnetic tape being one-sided in the tape width direction, in winding the magnetic tape MT in a tape reel 50 composed of a hub 51 and a pair of upper flange 52 and lower flange 53 as shown in FIG. 4A, causes as shown in FIG. 4B an occurrence of a so called “winding disturbance” in which a tape edge E1 becomes concave/convex by flying out in a clearance provided between the tape edge E1 and inner surface 52a of upper flange 52 of the tape reel 50.

The occurrence of the winding disturbance produces such problems as follows: (1) because a position in the tape width direction of the magnetic tape varies in a winding and/or paying-off of the magnetic tape, a running of the magnetic tape becomes unstable and the recording/reproducing characteristics of the magnetic tape becomes unable to be favorably kept; (2) in the winding and/or paying-off of the magnetic tape, tape edges of the magnetic tape are damaged abutting with inner surfaces of flanges of a tape reel; and (3) when a strong impact is added to the tape reel, the tape edges of the magnetic tape are damaged clashing with the inner surfaces of flanges of the tape reel.

Because of the causes described above, in order to prevent the tension given to the magnetic tape from being one-sided in the tape width direction of the magnetic tape, it is requested to control the tension in the tape width direction of the magnetic tape to become uniform, however the conventional tension controller described in the patent document cannot control the tension in the tape width direction of the magnetic tape to become uniform.

### SUMMARY OF THE INVENTION

An exemplary object of the present invention is to provide a tension controller of the magnetic tape which can control tension in a tape width direction of a running magnetic tape to become uniform.

The tension controller of the magnetic tape related to the invention is a controller to control tension in a tape width direction of a running magnetic tape to become uniform and is characterized by being equipped with a tension detecting unit detecting a tension distribution in the tape width direction of the magnetic tape; a tension adjusting unit eliminating a tension difference in the tape width direction by pushing a portion where the tension is weaker; and a control unit controlling the tension adjusting unit so that the tension in the tape width direction of the magnetic tape becomes uniform, based on a detection result of the tension detecting unit.

The tension controller of the magnetic tape thus composed enables the tension in the tape width direction of the running magnetic tape to become controlled so as to become uniform by pushing the portion where the tension is weaker with the tension adjusting unit and eliminating the tension difference in the tape width direction. Meanwhile, the tension distribution in the tape width direction of the magnetic tape is detected by the tension detecting unit. In addition, operation of the tension adjusting unit is controlled by the control unit, based on the detection result of the tension detecting unit.

In addition, the tension detecting unit is characterized by having two rollers disposed in a row in the width direction of the magnetic tape, disc springs universally rotationally supporting the rollers at their ends, respectively, a support platform fixedly supporting base ends of the disc springs, and strain gauges pasted on the disc springs, wherein the rollers are disposed so as to contact a surface of the magnetic tape.

The tension detecting unit thus composed enables the tension distribution in the width direction of the magnetic tape to be detected by respectively detecting bendings of the disc springs occurring when the rollers are pushed by the running magnetic tape, with strain gauges 14 pasted on the disc spring.

The tension adjusting unit is characterized by having two rollers disposed in a row in the width direction of the magnetic tape, a support unit universally rotationally supporting the rollers, respectively, and a move mechanism giving pushing force to the rollers by moving the support unit, wherein the rollers are disposed so as to contact the surface of the magnetic tape.

The tension adjusting unit thus composed makes it possible to give the pushing force to the rollers supported by the support unit by moving the support unit with the move mechanism. And it enables the tension in the width direction of the running magnetic tape to become uniform by pushing a weaker portion of the tension in the width direction of the running magnetic tape and eliminating the tension difference in the tape width direction. Meanwhile, the pushing force given to the rollers, that is, an amount which the move mechanism moves the support unit is controlled by the control unit.

The control unit is characterized by being composed so that the tension adjusting unit controls a portion of the magnetic tape to be pushed and the pushing force, based on the detection result of the tension detecting unit.

The control unit thus composed, based on the tension distribution in the tape width direction of the magnetic tape, obtains the portion in the tape width direction where the tension is weaker, and calculates force pushing the portion where the tension is weaker in order to make the tension distribution in the tape width direction uniform. Then, it outputs a control signal corresponding to the pushing force in the tension adjusting unit, and the tension adjusting unit controls the portion of the magnetic tape to be pushed and the pushing force.

### BRIEF DESCRIPTION OF THE DRAWINGS

FIG. 1 is a general configuration drawing schematically showing a winder 40 and a tension controller 1 installed at the winder 40.

FIG. 2 is a perspective drawing showing a tension detecting unit 10 included in the tension controller 1 in FIG. 1.

FIG. 3 is a perspective drawing showing a tension adjusting unit 20 included in the tension controller 1 in FIG. 1.

FIG. 4A is a perspective drawing showing a tape reel 50. FIG. 4B is a section drawing in a line C-C and shows a state in which a winding disturbance occurs.

### DESCRIPTION OF THE PREFERRED EMBODIMENTS

Hereinafter, one of embodiments of tension controller of the magnetic tape (hereinafter simply referred to as “tension controller” related to the present invention will be described in detail, referring to drawings as needed. In the embodiment the tension controller is assumed to be installed at a winder which is a winding device of the magnetic tape.

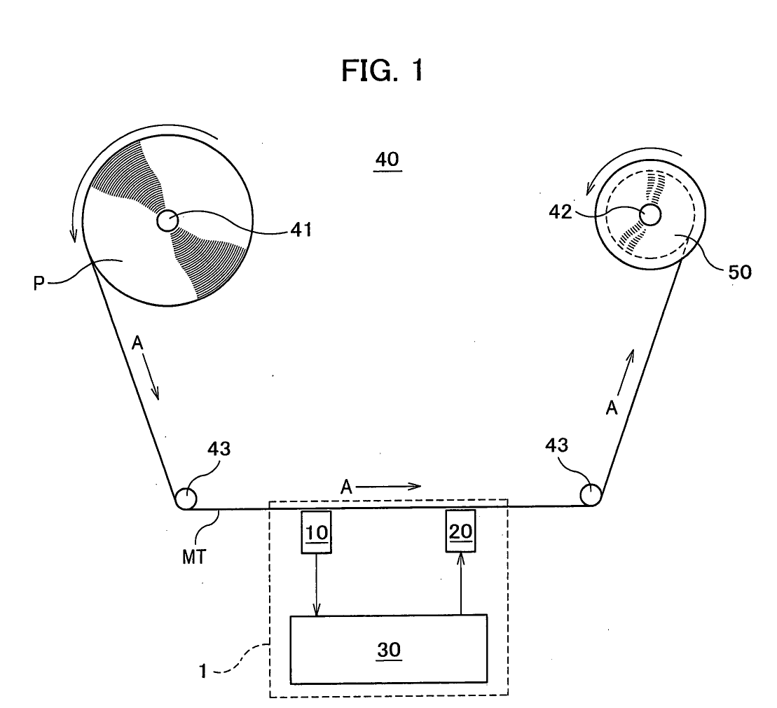

Firstly, the winder where the tension controller related to the invention is installed is described referring to FIG. 1.

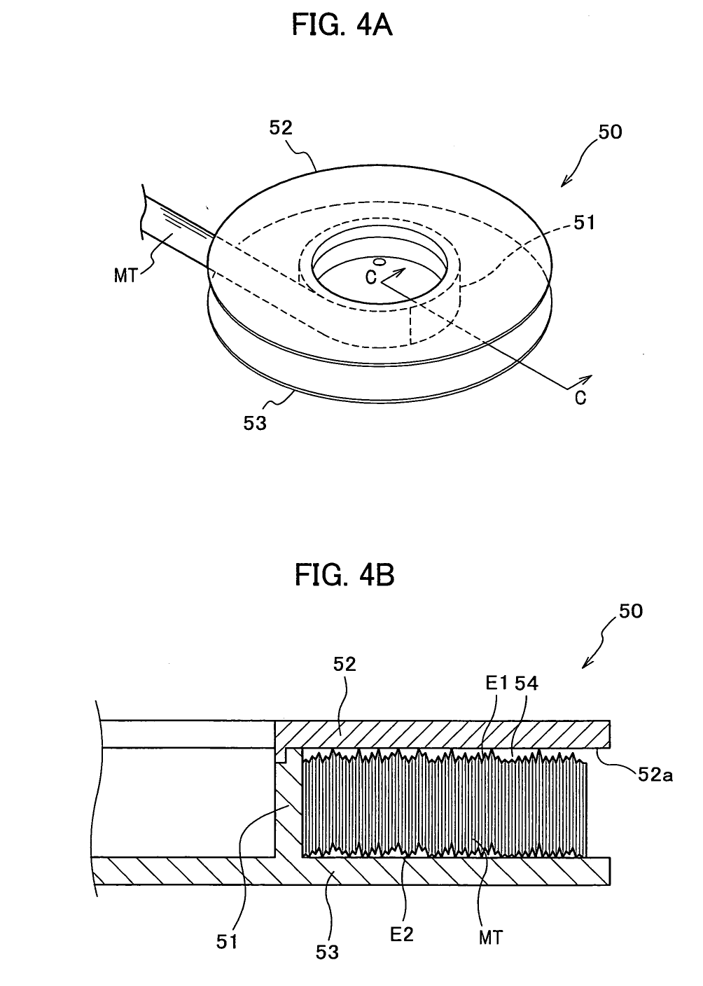

A winder 40 shown in FIG. 1 is a device to wind a magnetic tape MT supplied from a pancake reel P on a tape reel 50 (see FIG. 4A) by a predetermined amount and to cut it. The winder 40 is mainly equipped with a pancake reel rotating reel 41 on which the pancake reel P is inserted, a tape reel rotating shaft 42 on which the tape reel 50 is inserted, and a plurality of guide rollers 43 provided between the pancake reel rotating reel shaft 41 and tape reel rotating shaft 42. Meanwhile, the pancake reel P is a so called pancake-shape wound reel which is cut into a width defined by a product standard from a raw tape of a wider magnetic tape manufactured through a predetermined manufacture process.

In addition, although not shown in FIG. 1, the winder 40 is also equipped with a tape amount (tape length) adjusting means adjusting an amount of the magnetic tape MT wound on the tape reel 50, a magnetic tape cutting means cutting the tape MT when the tape MT being wound by the predetermined amount on the tape reel 50, a tension controlling means controlling tension in a longitudinal direction (tape running direction A) of the tape MT, a running speed adjusting means adjusting a running speed of the tape MT, and the like.

The winder 40 thus composed pays off the tape MT from the pancake reel P inserted on the pancake reel rotating reel 41 by rotating the pancake reel rotating reel 41 and tape reel rotating shaft 42 with a drive motor not shown in the drawing. Then, the tape MT paid off from the pancake reel P runs within the winder 40 guided by the rollers 43 and wound on the tape reel 50 inserted on the tape reel rotating shaft 42.

Next, the tension controller 1 related to the invention will be described referring to FIGS. 1 to 3.

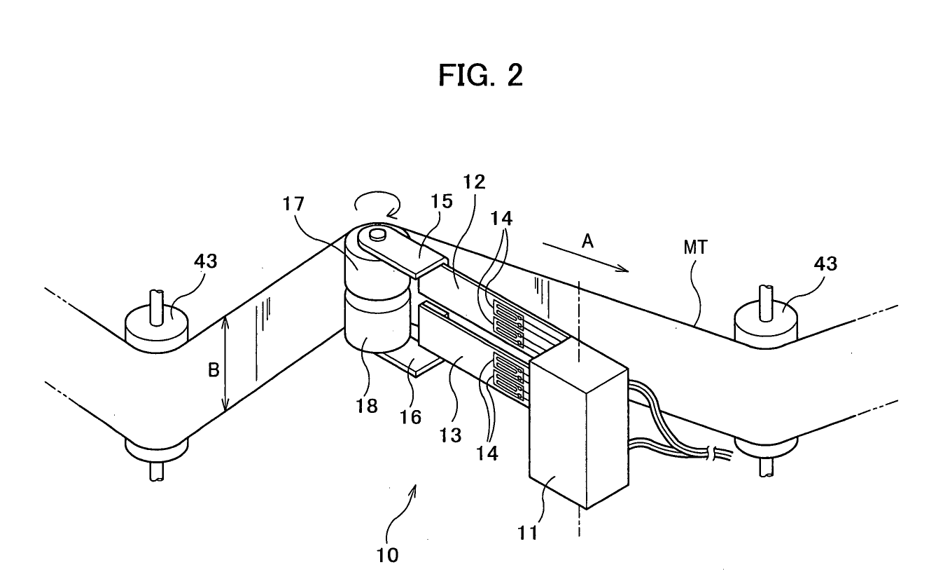

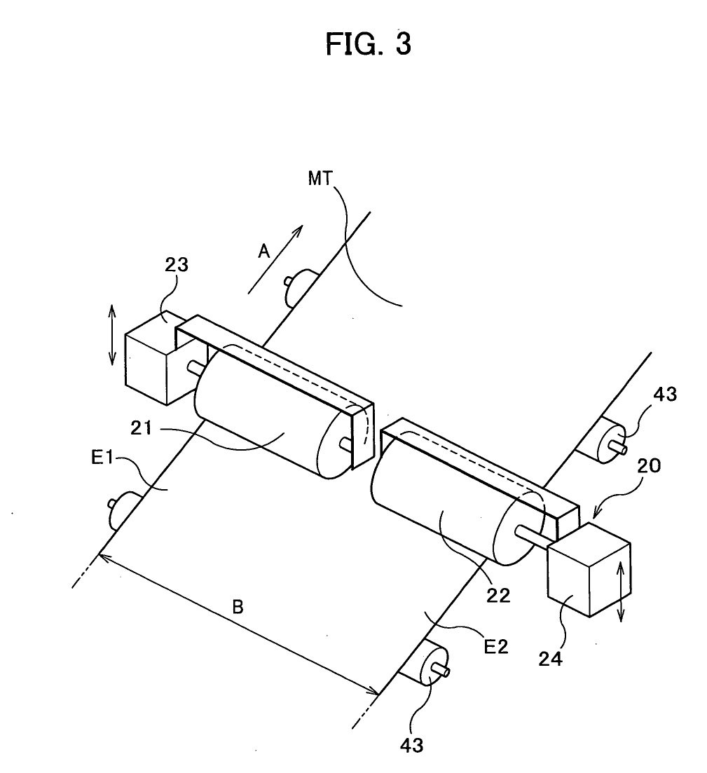

The tension controller 1 shown in FIG. 1 is a controller to control tension distribution in tape width directions B (see FIGS. 2 and 3) of the tape MT to become uniform. It is equipped with a tension detecting unit 10, a tension adjusting unit 20 disposed at a downstream side of the tension detecting unit 10, and a control unit 30 connected with the tension detecting unit 10 and tension adjusting unit 20. Meanwhile, the “downstream side” is the downstream side in the running direction A of the tape MT. Below, each unit of the tension controller 1 is described in detail.

The tension detecting unit 10 detects the tension distribution in the tape width directions B of the tape MT. It is, as shown in FIG. 2, equipped with a support platform 11; two disc springs 12 and 13 of which base ends are fixed at the support platform 11, and which are disposed in a row in the tape width directions B of the tape MT; strain gauges 14 pasted on surfaces of the disc springs 12 and 13 by two pieces for each; and rollers 17 and 18 universally rotationally supported cantilevered by hold plates 15 and 16 attached to top ends of the disc springs 12 and 13. Meanwhile, as shown in FIG. 1, guide rollers 43 are provided at an upstream side and downstream side of the tension detecting unit 10.

In the disc springs 12 and 13, for example, it is preferable to use springs shaped of phosphorus bronze which is high in strength and has an excellent spring property.

In the strain gauges 14, as a material of gauge wires a metal and semiconductor are used. The strain gauges 14 are pasted side by side on the surfaces of the disc springs 12 and 13 in the tape width directions B of the tape MT. That is, in two disc springs 12 and 13 total four strain gauges 14 ranks along the tape width directions B of the tape MT.

The rollers 17 and 18 are, for example, shaped of stainless steel and formed into a cylindrical shape with a high accurate circularity. As the rollers 17 and 18 same things are used and they are disposed so that their mutual rotation axes accord with each other.

The tension detecting unit 10 thus composed enables the tension distribution in the tape width directions B of the tape MT to be detected by respectively detecting bendings of the disc springs 12 and 13, which occur in the rollers 17 and 18 being pushed by the running tape MT, with the strain gauges 14 pasted on the disc springs 12 and 13. A detection result of the tension detecting unit 10 is output in the control unit 30.

The tension adjusting unit 20 makes the tension in the tape width directions B of the tape MT uniform. It is, as shown in FIG. 3, equipped with two rollers 21 and 22 disposed in a row in the tape width directions B of the tape MT, support units 23 and 24 universally rotationally cantilever-supporting the rollers 21 and 22, and a move mechanism giving the roller 21 (22) the pushing force by moving one of the support units 23 and 24. Meanwhile, as shown in FIG. 1, the guide rollers 43 are provided at the upstream side and downstream side of the tension adjusting unit 20.

The rollers 21 and 22 are disposed so as to always contacting the surface of the tape MT: the roller 21 is disposed at one side of an edge E1 of the tape MT; the roller 22 is disposed at the other side of an edge E2 of the tape MT. These are, for example, shaped of stainless steel and formed into a cylindrical shape with a high accurate circularity. As the rollers 21 and 22 same things are used and they are disposed so that their mutual rotation axes accord with each other.

The tension adjusting unit 20 thus composed enables pushing force to be given to the roller 21 (22) supported at the support unit 23 (24) by moving the support unit 23 (24) with the move mechanism such as a stepping motor and ball screw mechanism not shown in the drawings. And it enables the tension in the width directions B of the tape MT to become uniform by pushing a weaker edge E1 (E2) of the tape MT with one of the rollers 21 and 22, and eliminating a tension difference between tension given to the edge E1 and another tension given to the edge E2. Meanwhile, the pushing force given to the roller 21 (22), that is, an amount which the move mechanism not shown in the drawings moves the support unit 23 (24) is controlled by the control unit 30.

Operation of the tension adjusting unit 20 being more precisely described, for example, when the tension given to the edge E1 is weaker than that given to the edge E2, the tension difference between the tension given to the edge E1 and that given to the edge E2 is eliminated by pushing the edge E1 with the roller 21 disposed at the side of the edge E1, thereby the tension in the tape width directions B of the tape MT can be made to be uniform. Meanwhile, the pushing force given to the roller 21 then is controlled by the control unit 30. In the case, also by pulling the roller 22 disposed at the side of the edge E2, the same effect as in pushing the roller 21 disposed at the side of the edge E1 can be obtained.

The control unit 30 controls the tension adjusting unit 20 based on the detection result of the tension detecting unit 10. To be more precise, it controls which one of rollers 21 and 22 of the tension adjusting unit 20 pushes the tape MT and the pushing force given to the roller 21 (22) then.

To be described in detail, after obtaining the difference between the tension given to the edge E1 and that given to the edge E2, the control unit 30 calculates the pushing force to be given to the roller 21 (22) disposed at a side where the tension is weaker in order to make the tension distribution in the width directions B uniform. Then outputting a control signal corresponding to the pushing force in the tension adjusting unit 20, the control unit 30 controls the force by which the roller 21 (22) pushes the tape MT.

Next, operation in making the tension distribution in the width directions B (see FIG. 3) of the tape MT uniform by the tension controller 1 thus composed is described referring to FIGS. 1 to 3.

In the winder 40 shown in FIG. 1, the tape MT paid off from the pancake reel P inserted on the pancake reel rotation shaft 41 runs within the winder 40 guided by the guide rollers 43, and is wound on the tape reel 50 inserted on the tape reel rotation shaft 42.

In the running of the tape MT, the tension detecting unit 10 detects the tension distribution in the width directions B of the tape MT by respectively detecting the bendings of the disc springs 12 and 13 which occur in the rollers 17 and 18 being pushed by the running tape MT, with the strain gauges 14 pasted on the disc springs 12 and 13 (see FIG. 2). The detection result of the tension detecting unit 10 is output in the control unit 30 (see FIG. 1).

When the detection result of the tension detecting unit 10 is output in the control unit 30 (see FIG. 1), the control unit 30 controls the tension adjusting unit 20 based on the detection result of the tension detecting unit 10. To be more precise, it controls which one of rollers 21 and 22 of the tension adjusting unit 20 pushes the tape MT and the pushing force given to the roller 21 (22) then.

Then, the tension adjusting unit 20 gives, being controlled by the control unit 30, the pushing force to the roller 21 (22) supported at the support unit 23 (24) by moving the support unit 23 (24) with the move mechanism not shown in the drawings. And it makes the tension in the width directions B of the tape MT uniform by pushing the weaker edge E1 (E2) of the tape MT with one of the rollers 21 and 22 and eliminating the tension difference between the tension given to the edge E1 and that given to the edge E2.

Thus, the tension controller 1 related to the invention enables the tension in the width directions B of the tape MT to become uniform by pushing the weaker edge E1 (E2) of the tape MT with one of the rollers 21 and 22 and eliminating the tension difference between the tension given to the edge E1 and that given to the edge E2. Meanwhile, the tension distribution in the width directions B of the tape MT is detected by the tension detecting unit 10 and the pushing force given to the roller 21 (22), that is, the amount which the move mechanism not shown in the drawings moves the support unit 23 (24) is controlled by the control unit 30.

Thus, although one of embodiments of the present invention is described, the invention is not limited to such the embodiment and various variations are available as far as they are based on the technical ideas of the invention.

For example, in the embodiment, although the tension is adjusted by pushing the edge E1 (E2) of tape width directions B of the magnetic tape MT with one of rollers 21 and 22 of the tension adjusting unit 20, the tension adjustment can also be composed by providing the tension adjusting unit 20 with more rollers and making not less than one roller push not less than one place in the tape width directions B of the tape MT.

What is claimed is:

1. A tension controller of a magnetic tape to control a tension distribution in a tape width direction of a running magnetic tape to become uniform, the controller comprising:
a tension detecting unit detecting the tension distribution in the tape width direction of said magnetic tape;
a tension adjusting unit pushing a weaker portion in tension in the tape width direction of said magnetic tape, and eliminating a tension difference in the tape width direction; and
a control unit controlling said tension adjusting unit so that the tension in the tape width direction of said magnetic tape becomes uniform, based on a detection result of said tension detecting unit.

2. A tension controller of a magnetic tape according to claim 1, wherein said tension detecting unit has a plurality of rollers disposed in a row in the tape width direction of said magnetic tape, disc springs universally rotationally supporting said rollers at top ends, respectively, a support platform fixedly supporting base ends of the disc springs, and strain gauges pasted on said disc springs, and disposes said rollers so as to contact a surface of said magnetic tape.

3. A tension controller of a magnetic tape according to claim 1, wherein said tension detecting unit has two rollers disposed in a row in the tape width direction of said magnetic tape, disc springs universally rotationally supporting said rollers at top ends, respectively, a support platform fixedly supporting base ends of the disc springs, and strain gauges pasted on said disc springs, and disposes said rollers so as to contact a surface of said magnetic tape.

4. A tension controller of a magnetic tape according to claim 1, wherein said tension adjusting unit has a plurality of rollers disposed in a row in the tape width direction of said magnetic tape, support units universally rotationally supporting said rollers, respectively, and a move mechanism giving pushing force to said rollers by moving said support units, and disposes said rollers so as to contact a surface of said magnetic tape.

5. A tension controller of a magnetic tape according to claim 2, wherein said tension adjusting unit has a plurality of rollers disposed in a row in the tape width direction of said magnetic tape, support units universally rotationally supporting said rollers, respectively, and a move mechanism giving pushing force to said rollers by moving said support units, and disposes said rollers so as to contact a surface of said magnetic tape.

6. A tension controller of a magnetic tape according to claim 1, wherein said tension adjusting unit has two rollers disposed in a row in the tape width direction of said magnetic tape, support units universally rotationally supporting said rollers, respectively, and a move mechanism giving pushing force to said rollers by moving said support units, and disposes said rollers so as to contact a surface of said magnetic tape.

7. A tension controller of a magnetic tape according to claim 3, wherein said tension adjusting unit has two rollers disposed in a row in the tape width direction of said magnetic tape, support units universally rotationally supporting said rollers, respectively, and a move mechanism giving pushing force to said rollers by moving said support units, and disposes said rollers so as to contact a surface of said magnetic tape.

8. A tension controller of a magnetic tape according to claim 1, wherein said control unit is composed so as to control a portion on which said tension adjusting unit pushes said magnetic tape and pushing force then, based on a detection result of said tension detecting unit.

9. A tension controller of a magnetic tape according to claim 2, wherein said control unit is composed so as to control a portion on which said tension adjusting unit pushes said magnetic tape and pushing force then, based on a detection result of said tension detecting unit.

10. A tension controller of a magnetic tape according to claim 3, wherein said control unit is composed so as to control a portion on which said tension adjusting unit pushes said magnetic tape and pushing force then, based on a detection result of said tension detecting unit.

11. A tension controller of a magnetic tape according to claim 4, wherein said control unit is composed so as to control a portion on which said tension adjusting unit pushes said magnetic tape and pushing force then, based on a detection result of said tension detecting unit.

12. A tension controller of a magnetic tape according to claim 5, wherein said control unit is composed so as to control a portion on which said tension adjusting unit pushes said magnetic tape and pushing force then, based on a detection result of said tension detecting unit.

13. A tension controller of a magnetic tape according to claim 6, wherein said control unit is composed so as to control a portion on which said tension adjusting unit pushes said magnetic tape and pushing force then, based on a detection result of said tension detecting unit.

14. A tension controller of a magnetic tape according to claim 7, wherein said control unit is composed so as to control a portion on which said tension adjusting unit pushes said magnetic tape and pushing force then, based on a detection result of said tension detecting unit.

15. A tension controller of an optical tape to control a tension distribution in a tape width direction of a running optical tape to become uniform, the controller comprising:
a tension detecting unit detecting the tension distribution in the tape width direction of said optical tape;
a tension adjusting unit pushing a weaker portion in tension in the tape width direction of said optical tape, and eliminating a tension difference in the tape width direction; and
a control unit controlling said tension adjusting unit so that the tension in the tape width direction of said optical tape becomes uniform, based on a detection result of said tension detecting unit.

16. A tension controller of an optical tape according to claim 15, wherein said tension detecting unit has a plurality of rollers disposed in a row in the tape width direction of said optical tape, disc springs universally rotationally supporting said rollers at top ends, respectively, a support platform fixedly supporting base ends of the disc springs, and strain gauges pasted on said disc springs, and disposes said rollers so as to contact a surface of said optical tape.

17. A tension controller of an optical tape according to claim 15, wherein said tension detecting unit has two rollers disposed in a row in the tape width direction of said optical tape, disc springs universally rotationally supporting said rollers at top ends, respectively, a support platform fixedly supporting base ends of the disc springs, and strain gauges pasted on said disc springs, and disposes said rollers so as to contact a surface of said optical tape.

18. A tension controller of an optical tape according to claim 15, wherein said tension adjusting unit has a plurality of rollers disposed in a row in the tape width direction of said optical tape, support units universally rotationally supporting said rollers, respectively, and a move mechanism giving pushing force to said rollers by moving said support units, and disposes said rollers so as to contact a surface of said optical tape.

19. A tension controller of an optical tape according to claim 16, wherein said tension adjusting unit has a plurality of rollers disposed in a row in the tape width direction of said optical tape, support units universally rotationally supporting said rollers, respectively, and a move mechanism giving pushing force to said rollers by moving said support units, and disposes said rollers so as to contact a surface of said optical tape.

20. A tension controller of an optical tape according to claim 15, wherein said tension adjusting unit has two rollers disposed in a row in the tape width direction of said optical tape, support units universally rotationally supporting said rollers, respectively, and a move mechanism giving pushing force to said rollers by moving said support units, and disposes said rollers so as to contact a surface of said optical tape.
